(19) United States
(12) Patent Application Publication
(10) Pub. No.: US 2005/0108737 A1
(43) Pub. Date: May 19, 2005

(54) Optical drive

(76) Inventor: Yen-Jen Chang, Kaohsiung City (TW)

Correspondence Address: SNELL & WILMER;ONE ARIZONA CENTER, 400 EAST VAN BUREN, PHOENIX, AZ, 850040001, US

(21) Appl. No.: 10/986,746

(22) Filed: Nov. 12, 2004

(30) Foreign Application Priority Data
Nov. 14, 2003 (TW) 92131953

(51) Int. Cl. G11B 17/03; G11B 17/04; G11B 33/02

(52) U.S. Cl. 720/601

(57) ABSTRACT

An optical drive includes a casing, an optical module, and an adjustment unit. The optical module includes a tray. The tray is configured to support a disk. The adjustment unit disposed on the casing is configured to support the optical module. The adjustment unit moves flexibly so as to adjust the position of the tray with respect to the casing.

### CROSS-REFERENCE TO RELATED APPLICATION

This application claims the right of priority based on Taiwan Patent Application No. 092131953 entitled “Disk Player/Recorder,” filed on Nov. 14, 2003, which is incorporated herein by reference and assigned to the assignee herein.

### FIELD OF INVENTION

The present invention generally relates to an optical drive, and more particularly to an optical drive with a tray-position adjustment unit.

### BACKGROUND OF THE INVENTION

Because of their high recording density, short access time, excellent data preservation, and better performance, optical disk type data storing products gradually replace conventional tape type electronic devices. Particularly, the digital video products of home entertainment advance as killer products, replacing the role of conventional video cassette recorder/players or tape recorders.

The disk type electronic device generally includes an optical module for accessing data on a disk and a processing module for converting the data into user perceptible forms, such as words, images, or audio. For a digital video disk (DVD) player, the optical module includes a tray and an optical pickup head. When a user intends to retrieve data or watch a movie from a disk, the tray slides out of the DVD player so that the user can place the disk on the tray. Then, the tray carries the disk into the player so that the optical pickup head reads data from the disk. Therefore, during assembly of the player, the path for the tray to move into or out of the player, as well as the integral appearance of the player, must be taken into consideration.

For example, components of a player are generally manufactured with tolerances. In the case that the tolerances of the relevant components affect the movement of the tray, at least some of these components must be re-made or modified, resulting in an increase of manufacturing cost and assembly time. Furthermore, even if minor relevant tolerances do not hinder the movement of the tray, the integral appearance of the player will be degraded when the position of the tray is shifted with respect to the opening of the player casing. In other words, as consumers have a higher expectation on the outer appearances of electronic products, whether the tray is appropriately centered or positioned and thus maintaining even gaps with respect to the edges of the opening of the player casing directly affects the perceived external quality from the user's standpoint.

Therefore, there is a need to provide an optical drive, which is capable of adjusting the position of the optical module.

### SUMMARY OF THE INVENTION

An object of the present invention is to provide an optical drive, such as a disk player/recorder that includes an adjustment unit capable of adjusting the position of an optical module with respect to the casing. Thereby, the assembly interferences between the components induced by manufacture tolerances can be effectively compensated.

Another object of the present invention is to provide an optical drive that is capable of multi-directionally adjusting the position of a tray of an optical module with respect to a casing so that the manufacturing cost and assembly time can be minimized.

Still another object of the present invention is to provide an optical drive that has a support plate and an elastic mechanism, capable of flexibly adjusting the position of a tray so that the optical drive not only allows the tray to move in/out easily, but also has an enhanced integral appearance.

In one embodiment, the present invention provides an optical drive, such as a disk player/recorder, which includes a casing, an optical module, and an adjustment unit. The optical module includes a tray. The tray supports a disk. The adjustment unit for supporting the optical module is disposed on the casing. The adjustment unit moves flexibly so as to adjust the position, e.g. the vertical position, of the tray with respect to the casing. The optical module further includes an optical unit, which is configured to access data on the disk or to write data onto the disk.

In an exemplary embodiment, a decoration panel is disposed on one end of the tray. The casing includes a front panel with an opening for allowing the tray to move in or out of the casing. The tray is so adjusted that the decoration panel and the opening are distanced with a substantial uniform gap. Preferably, the gap is minimized so that the decoration panel substantially covers the opening when the tray is accommodated in the casing.

In an exemplary embodiment, the adjustment unit includes a support plate for supporting the optical module and an elastic mechanism for connecting the support plate and the casing. For example, the elastic mechanism includes a leaf spring and a bolt. The leaf spring is disposed on the casing, and the bolt connects the leaf spring and the support plate so as to control the elastic movement of the leaf spring. A slot is in the leaf spring, and the elastic mechanism further includes a rivet positioned in the slot for securing the leaf spring on the casing. When the bolt controls the elastic movement of the leaf spring, the leaf spring moves along the slot. Alternatively, in another exemplary embodiment, the elastic mechanism includes a spring and a bolt. The spring is disposed between the support plate and the casing, while the bolt connects the support plate and the casing so as to control the elastic movement of the spring. The spring defines a central axis, and the bolt is positioned along the central axis.

Furthermore, a groove is in the support plate. The optical module is positioned on the support plate and is movable along the groove so as to adjust the position, e.g. the horizontal position of the tray with respect to the casing.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a 3-dimensional view illustrating an optical drive in accordance with one embodiment of the present invention;

FIG. 2 is a schematic view illustrating an optical drive without cover in accordance with one embodiment of the present invention;

FIG. 3 is a schematic view illustrating an optical drive with cover and front panel in accordance with one embodiment of the present invention;

FIG. 4 is a schematic view illustrating an adjustment unit disposed on an casing in accordance with one embodiment of the present invention;

FIGS. 5A and 5B are a 3-dimensional view and a cross-sectional view illustrating an elastic mechanism in accordance with one embodiment of the present invention; and

FIG. 6 is a cross-sectional view illustrating an elastic mechanism in accordance with another embodiment of the present invention.

### DETAILED DESCRIPTION

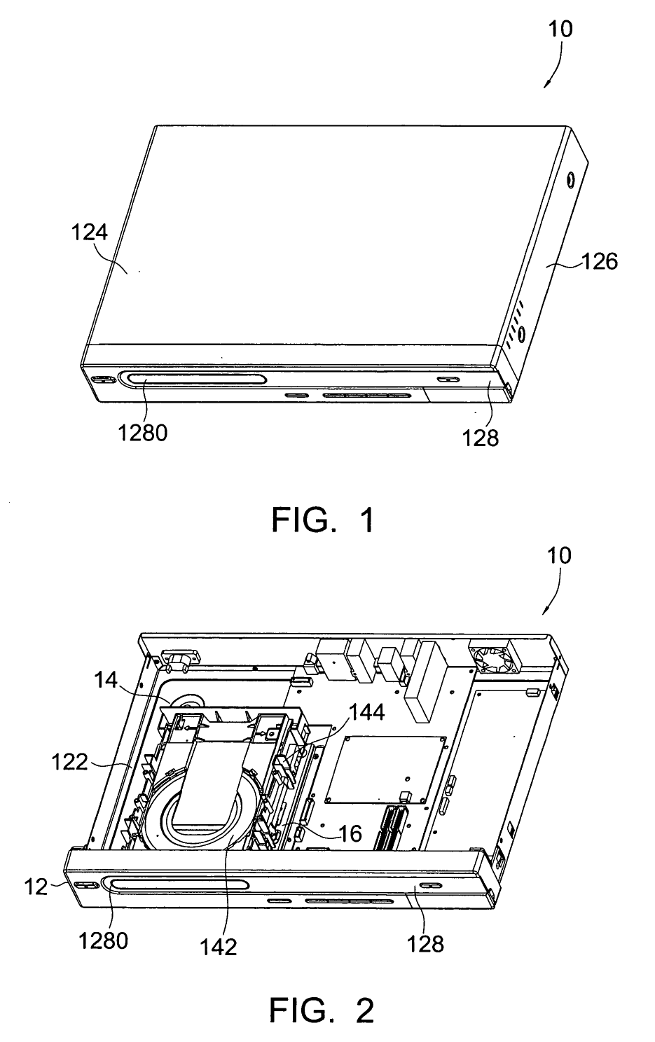

The present invention provides an optical drive, which is capable of adjusting the position of a tray of an optical module with respect to a casing so as to eliminate the interference among components induced by manufacture tolerances. With the adjustable feature, the integral appearance of the optical drive can be significantly enhanced. The optical drive can be, for example, a disk player/recorder including a DVD player, a VCD player, a recordable DVD player, or any disk handling apparatus as appropriate. FIGS. 1-6 illustrate preferred embodiments of the present invention.

Referring to FIGS. 1 and 2, in one embodiment of the present invention, 3-dimensional views of an optical drive, such as a disk player/recorder with/without a cover are respectively illustrated. The disk player/recorder 10 includes a casing 12, an optical module 14, and an adjustment unit 16. The optical module 14 includes a tray 142 and an optical unit (i.e. an optical pickup head) 144. The tray 142 is configured to support a disk (not shown), and the optical unit is configured to access data on the disk or to write data onto the disk. The adjustment unit 16 is disposed on the casing 12 and configured to support the optical module 14. The adjustment unit 16 is capable of moving elastically so as to adjust the position of the tray 142 with respect to the casing 12.

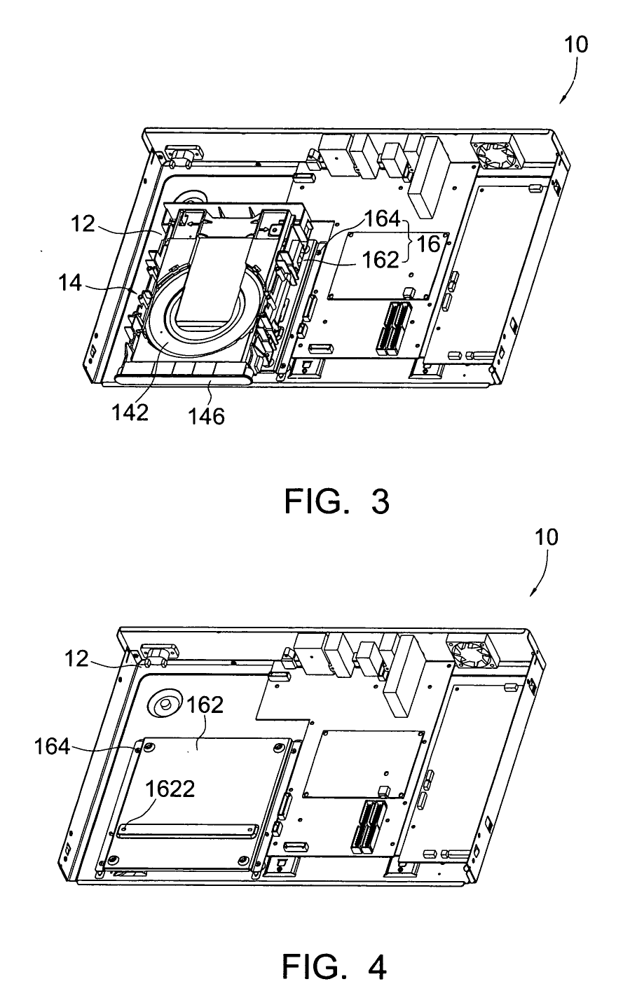

For example, the casing 12 is constructed by a plurality of plates, which include a bottom plate 122, a cover plate 124, side boards 126, and a front panel 128. The front panel 128 has an opening 1280 for allowing the tray 142 of the optical module 14 to move into or out of the casing 12 so that a user can place or retrieve the disk. When the tray 142 carries the disk moving into the casing 12, the optical unit 144 is capable of accessing data on the disk. As shown in FIG. 3, the optical module 14 further includes a decoration panel 146, which is disposed at the front end of the tray 142 and matches the front panel 128 so as to enhance the integral appearance of the disk player/recorder 10. When the front panel 128 or the optical module 14 is manufactured with varied tolerances, the assembly of the disk player/recorder 10 encounters interferences between components. Therefore, the adjustment unit 16 is configured to move elastically so as to adjust a position of the tray 142 with respect to the casing 12. In other words, when the disk player/recorder 10 of the present invention is assembled, the position of the adjustment unit 16 is adjustable so that the position of the tray 142 is adjusted to center the decoration panel 146 within the opening 1280. Therefore, the decoration panel 146 and edge of the opening 1280 are distanced with a uniform gap. Preferably, the decoration panel 146 is so designed that substantially covers the opening 1280 of the front panel 128 when the tray 142 is in the casing 12. In other words, the gap between the decoration panel 146 and edge of the opening 1280 is preferably minimized. In such an arrangement, the integral appearance of the disk player/recorder 10 is enhanced, and the interferences between components are eliminated.

Referring to FIG. 4, the adjustment unit 16 includes a support plate 162 and an elastic mechanism 164. The support plate 162 is configured to support the optical module 14. The elastic mechanism 164 connects the support plate 162 and the casing 12. For example, the optical module 14 is mounted on the support plate 162, while the elastic mechanism 164 is disposed on the bottom plate 122 for elastically supporting the support plate 162. The vertical position of the elastic mechanism 164 is adjusted as the disk player/recorder is assembled so that the position of the tray 142 is optimized with respect to the casing 12. Preferably, the tray 142 is so adjusted that the decoration panel 146 is centered within the opening 1280 to enhance the integral appearance of the disk player/recorder 10.

Furthermore, a groove 1622 is formed in the support plate 162. The optical module 14 is positioned on the support plate 162 and is movable along the groove 162 so as to adjust a second position of the tray 142 with respect to the casing 12, such as the horizontal position. In other words, when the disk player/recorder is assembled, the optical module 14 is allowed to move horizontally along the groove 1622 to an optimized horizontal position with respect to the casing 12. Then, secure elements, such as bolts or screws, are used to secure the optical module 14 on the support plate 162.

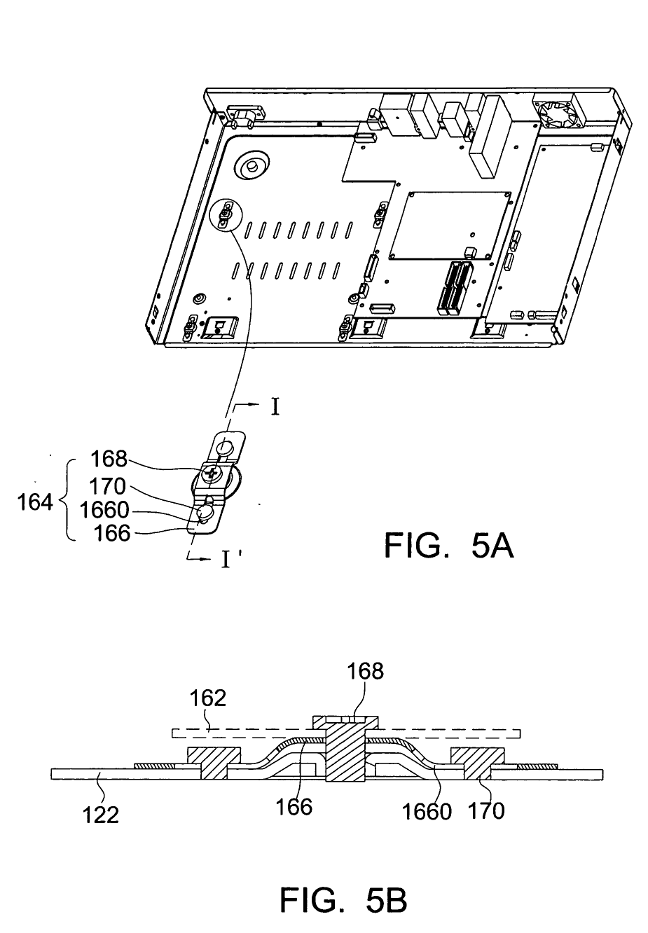

FIG. 5A illustrates an exemplary embodiment of the elastic mechanism 164, and for clear description, the support plate 162 is not shown. FIG. 5B is an enlarged partial cross-sectional view along line I—I′ of FIG. 5A. The dotted line in FIG. 5B represents the position of the support plate 162 when assembled. Referring to both FIGS. 5A and 5B, the elastic mechanism 164 includes a leaf spring 166, a bolt 168, and a rivet 170. The leaf spring 166 has a slot 1660 formed therein, and is disposed on the casing 120. The bolt 168 is configured to connect the leaf spring 166 and the support plate 162 so as to control the elastic movement of the leaf spring 166. In other words, the rivet 10 is positioned in the slot 1660 for securing the leaf spring 166 on the bottom plate 122 so that the distance between the support plate 162 and the bottom plate 122 can be adjusted. When the bolt 168 controls the elastic movement of the leaf spring 166, the leaf spring 166 moves along the slot 1660. For example, when the vertical distance of the tray 142 with respect to the casing opening 1280 needs to be reduced, the bolt 168 is tightened to press the leaf spring 166, and the leaf spring 166 moves down along the slot 1660. When the vertical distance of the tray 142 with respect to the casing opening 1280 needs to be increased, the bolt 168 is loosened to allow the leaf spring 166 to move up along the slot 1660.

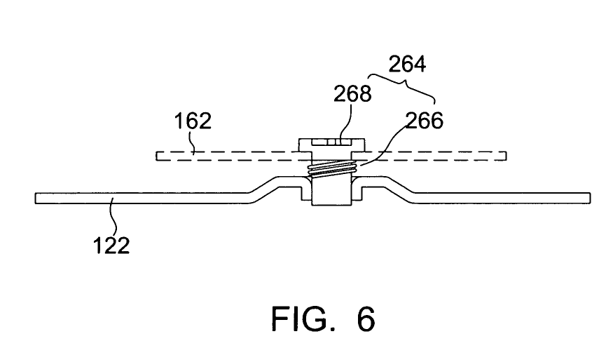

The elastic mechanism can have other modifications and is not limited to the exemplary embodiment described herein. As shown in FIG. 6, in another exemplary embodiment, the elastic mechanism 266 includes a spring 266 and a bolt 268. The spring 266 is disposed between the casing 12 and the support plate 162. The bolt 268 is configured to connect the support plate 162 and the casing 12 so as to control the elastic movement of the spring 266. In other words, the spring 266 defines a central axis, and the bolt 268 is positioned along the central axis so that the distance between the support plate 162 and the bottom plate 122. can be adjusted. When the bolt 268 controls the elastic movement of the spring 266, the spring 266 moves along the direction of the central axis. For example, when the vertical distance of the tray 142 with respect to the casing opening 1280 needs to be reduced, the bolt 268 is tightened to press the spring 266, and the spring 266 is compressed along the direction of the central axis. When the vertical distance of the tray 142 with respect to the casing opening 1280 needs to be increased, the bolt 168 is loosened to allow the spring 266 to move up due to the elastic force.

The present invention has the advantages of using the elastic mechanism 164 or 264 of the adjustment unit 16 to adjust the vertical distance between the support plate 162 and the bottom plate 122. Therefore, the vertical position of the tray 142 of the optical module 14 with respect to the opening 1280 of the front panel 128 is adjustable. Similarly, by adjusting the position of the optical module 14 along the groove 1622 of the support plate 162, the horizontal position with respect to the opening 1280 of the front panel 128 is adjustable. The optical drive of the present invention is capable of multi-directional adjusting the position of the tray 142 with respect to the casing 12, and accordingly, the remake or modification of components of the optical drive due to the manufacture tolerances is eliminated. Therefore, the manufacturing cost and the assembly time are minimized.

Although specific embodiments have been illustrated and described, it will be obvious to those skilled in the art that various modifications may be made without departing from the scope of the appended claims.

1. An optical drive, comprising:
a casing;
an optical module comprising a tray, wherein said tray is configured to support a disk; and
an adjustment unit, disposed on said casing, for supporting said optical module,
wherein said adjustment unit moves flexibly so as to adjust a first position of said tray with respect to said casing.

2. The optical device of claim 1, wherein said casing comprises a front panel with an opening, and said first position of said tray is adjusted with respect to said opening.

3. The optical device of claim 2 further comprising a decoration panel being disposed on one end of said tray, wherein said tray is so adjusted that edge of said opening of said front panel and said decoration panel are distanced with a substantial uniform gap.

4. The optical drive of claim 3, wherein said gap is minimized so that said decoration panel substantially covers said opening.

5. The optical drive of claim 1, wherein said adjustment unit comprises a support plate for supporting said optical module and an elastic mechanism for connecting said support plate and said casing.

6. The optical drive of claim 5, wherein said elastic mechanism comprises a leaf spring disposed on said casing and a bolt for connecting said leaf spring and said support plate so as to control a flexible movement of said leaf spring.

7. The optical drive of claim 6, wherein a slot is formed in said leaf spring, said flexible mechanism further comprises a rivet positioned in said slot for securing said leaf spring on said casing, and said leaf spring moves along said slot when said bolt controls said flexible movement of said leaf spring.

8. The optical drive of claim 5, wherein said elastic mechanism comprises a spring disposed between said casing and said support plate, and a bolt for connecting said support plate and said casing so as to control an flexible movement of said spring.

9. The optical drive of claim 8, wherein said spring has a central axis, and said bolt is positioned along said central axis.

10. The optical drive of claim 5, wherein a groove is formed in said support plate, and said optical module is positioned on said support plate and is movable along said groove so as to adjust a second position of said tray with respect to said casing.

11. The optical drive of claim 10, wherein said fist position and said second position are respectively a vertical position and a horizontal position of said tray with respect to said casing.

12. The optical drive of claim 1, wherein said optical module further comprises an optical unit for accessing data on said disk or writing data onto said disk.

13. An optical drive, comprising:
a casing comprising a front panel with an opening;
an optical module comprising a tray, wherein said tray is configured to support a disk;
a decoration panel being disposed on one end of said tray; and
an adjustment unit, disposed on said casing, for supporting said optical module,
wherein said adjustment unit moves flexibly so as to adjust a first position of said decoration panel with respect to said opening so that said decoration panel and edge of said opening are distanced with a substantial uniform gap.

14. The optical drive of claim 13, wherein said adjustment unit comprises a support plate for supporting said optical module and an elastic mechanism for connecting said support plate and said casing.

15. The optical drive of claim 14, wherein said elastic mechanism comprises a leaf spring disposed on said casing, and a bolt for connecting said leaf spring and said support plate so as to an control flexible movement of said leaf spring.

16. The optical drive of claim 15, wherein a slot is formed in said leaf spring, said elastic mechanism further comprises a rivet positioned in said slot for securing said leaf spring on said casing, and said leaf spring moves along said slot when said bolt controls said flexible movement of said leaf spring.

17. The optical drive of claim 14, wherein said elastic mechanism comprises a spring disposed between said casing and said support plate, and a bolt for connecting said support plate and said casing so as to control an flexible movement of said spring.

18. The optical drive of claim 17, wherein said spring has a central axis, and said bolt is positioned along said central axis.

19. The optical drive of claim 14, wherein a groove is formed in said support plate, and said optical module is positioned on said support plate and is movable along said groove so as to adjust a second position of said tray with respect to said casing.

20. The optical drive of claim 19, wherein said fist position and said second position are respectively a vertical position and a horizontal position of said tray with respect to said casing.
